(19) United States
(12) Patent Application Publication
(10) Pub. No.: US 2024/0376247 A1
(43) Pub. Date: Nov. 14, 2024

(54) HINDERED ETHERAMINE POLYURETHANE CATALYSTS

(71) Applicant: HUNTSMAN PETROCHEMICAL LLC, The Woodlands, TX (US)

(72) Inventors: Matthew T. MEREDITH, The Woodlands, TX (US); Jingjun ZHOU, The Woodlands, TX (US); Zhiping SHAN, The Woodlands, TX (US); DiAnne PHAM, The Woodlands, TX (US)

(21) Appl. No.: 18/692,073

(22) PCT Filed: Sep. 16, 2022
(86) PCT No.: PCT/US2022/043768

§ 371 Date: Mar. 14, 2024

Related U.S. Application Data
(60) Provisional application No. 63/351,091, filed on Jun. 10, 2022.
(60) Provisional application No. 63/244,972, filed on Sep. 16, 2021.

(51) Int. Cl. C08G 18/18; C08G 18/20; C08J 9/00; C08J 9/14; C08L 75/04

(52) U.S. Cl. CPC C08G 18/1833; C08G 18/2027; C08J 9/0061; C08J 9/143; C08L 75/04; C08J 2203/162; C08J 2375/04; C08J 2483/04; C08L 2203/14

(57) ABSTRACT

A polyol resin blend suitable for rigid foam applications having one or more active hydroxyl compounds, a silicone surfactant, a halogenated olefinic blowing agent, and an amine catalyst. The polyol resin blend can include from about 0.3% to about 7% by weight amine catalyst. The polyol resin blend may be used to form a polyurethane and/or polyisocyanurate foam.

### CROSS REFERENCE TO RELATED APPLICATIONS

This application claims priority to U.S. Provisional Patent Application Ser. No. 63/244,972 filed Sep. 16, 2021 and U.S. Provisional Patent Application Ser. No. 63/351,091 filed Jun. 10, 2022. The noted applications are incorporated herein by reference.

### FIELD

The present disclosure generally relates to catalysts for use in generating a thermosetting polyurethane and/or polyisocyanurate foam. More specifically, the present disclosure relates to polyurethane catalysts containing ether groups and sterically hindered amine groups.

### BACKGROUND

Thermosetting foams can have utility in a wide variety of material applications including, without limitation, insulation. Such foams can be produced by combining a polyisocyanate with a polyol resin blend which comprises a combination of at least a blowing agent, a polyol, and an amine catalyst. In order to produce an industrially viable foam, the polyol resin blend must impart sufficient strength to the foam and enable the foam to form sufficiently fast enough to maintain a desired cellular structure. For example, if the composition is not sufficiently quick enough or does not impart sufficient strength, the foam may collapse during formation or lack physical strength in its finished form, rendering the finished foam inadequate. The composition of the polyol resin blend can be adjusted in order to achieve the desired properties of the resulting foam.

Recently, new blowing agents have been introduced into the polyurethane and/or polyisocyanurate foam market that have little or no effect on ozone degradation or global warming in contrast to their predecessors, chlorofluorocarbons (CFCs) and hydrochlorofluorocarbons (HCFCs). These blowing agents, known as halogenated olefinic blowing agents, hydrofluoroolefins (HFOs), or hydrocholorofluoroolefins (HCFOs), are being widely adopted in spray thermosetting foam. The performance of spray thermosetting foam is dependent on the exothermic reaction between a polyisocyanate and a water-containing polyol resin blend that releases heat and carbon dioxide (CO₂), causing the blowing agent to boil and resulting in synchronous, rapid polymerization and cellular structure formation. Metal and amine catalysts can accelerate this reaction to acceptable rates, which is a necessary part of any sprayed thermosetting foam formulation.

Traditional spray thermosetting foam amine catalysts contain multiple methylamine groups which minimize steric hinderance around the amine group and enable faster catalysis of the polyurethane and/or polyisocyanurate foam-forming reactions while minimizing catalyst loading. Structures of several common sprayed thermosetting foam catalysts are provided below:

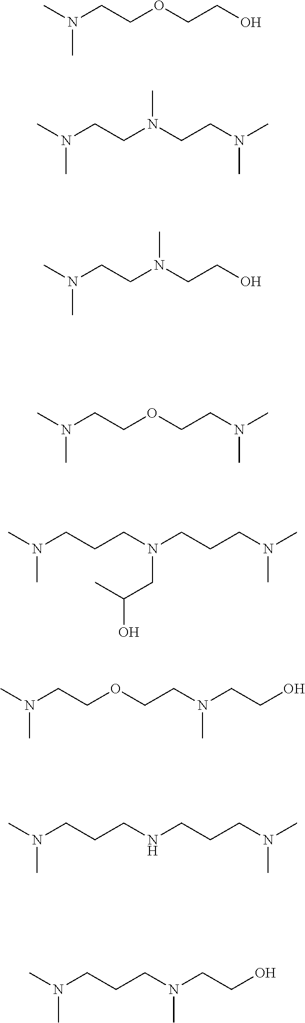

However, the use of such amine catalysts in polyol resins containing HFOs can result in unwanted reactions between the amines, blowing agents, and surfactants, resulting in the degradation or failure of the polyol resin blend. The unwanted reactions can cause, without limitation, the release of chloride and/or fluoride ions. These reactions can reduce the activity of catalysts present and can destroy the blowing agent. In addition, the fluoride ions that are eliminated from the HFO molecules attack the silicon atoms in the silicone surfactants, degrading the surfactants, which lowers the surfactant performance and weakens the cellular structure of the resulting foam. The above combination of reactions can result in polyol systems that are unstable, and if foams are sprayed using the unstable systems, the foams will not rise properly and can have irregular and inconsistent cell structure.

Despite the state of the art, there is a continuous need for the development of amine catalysts that can facilitate the rapid reaction between isocyanate and polyol resin blend but do not significantly affect the storage stability of the blend when using HFO blowing agents.

### BRIEF DESCRIPTION OF THE DRAWINGS

The features of the present disclosure can be understood in detail, a more particular description of the invention, may be had by reference to embodiments, some of which are illustrated in the appended drawings. It is to be noted, however, that the appended drawings illustrate only a typical embodiment of this disclosure and is therefore not to be considered limiting of its scope, for the disclosure may admit to other equally effective embodiments.

FIG. 1 is a graph illustrating the stability of an amine catalyst according to the present disclosure over a period of time.

FIG. 2 is a graph illustrating a rate-of-rise curve showing the measurement of cream time and catalyst speed.

FIG. 3 is a bubble graph illustrating the drift, curing speed, and cream time of various catalysts.

### DETAILED DESCRIPTION

Before explaining aspects of the present disclosure in detail, it is to be understood that the present disclosure is not limited in its application to the details of construction and the arrangement of components or steps or methodologies set forth in the following description. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference to the extent that they do not contradict the instant disclosure.

All of the compositions and/or methods disclosed herein can be made and executed without undue experimentation in light of the present disclosure. While the compositions and methods of the present disclosure have been described in terms of preferred embodiments, it will be apparent to those having ordinary skill in the art that variations may be applied to the compositions and/or methods and in the steps or sequences of steps of the methods described herein without departing from the concept, spirit, and scope of the present disclosure. All such similar substitutes and modifications apparent to those skilled in the art are deemed to be within the spirit, scope, and concept of the present disclosure.

As utilized in accordance with the present disclosure, the following terms, unless otherwise indicated, shall be understood to have the following meanings.

The use of the word “a” or “an”, when used in conjunction with the term “comprising”, “including”, “having”, or “containing” (or variations of such terms) may mean “one”, but it is also consistent with the meaning of “one or more”, “at least one”, and “one or more than one”.

The use of the term “or” is used to mean “and/or” unless clearly indicated to refer solely to alternatives and only if the alternatives are mutually exclusive.

If the specification states a component or feature “may,” “can,” “could,” or “might” be included or have a characteristic, that particular component or feature is not required to be included or have the characteristic.

Throughout this disclosure, the term “about” is used to indicate that a value includes the inherent variation of error for the quantifying device, mechanism, or method, or the inherent variation that exists among the subject(s) to be measured. For example, but not by way of limitation, when the term “about” is used, the designated value to which it refers may vary by plus or minus ten percent, or nine percent, or eight percent, or seven percent, or six percent, or five percent, or four percent, or three percent, or two percent, or one percent, or one or more fractions therebetween.

The use of “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it refers. In addition, the quantities of 100/1000 are not to be considered as limiting since lower or higher limits may also produce satisfactory results.

In addition, the phrase “at least one of X, Y, and Z” will be understood to include X alone, Y alone, and Z alone, as well as any combination of X, Y, and Z. Likewise, the phrase “at least one of X and Y” will be understood to include X alone, Y alone, as well as any combination of X and Y. Additionally, it is to be understood that the phrase “at least one of” can be used with any number of components and have the similar meanings as set forth above.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The phrases “in one example”, “in an example”, “according to one example”, and the like generally mean the particular feature, structure, or characteristic following the phrase is included in at least one example of the present disclosure, and may be included in more than one example of the present disclosure. Importantly, such phrases are non-limiting and do not necessarily refer to the same example but, of course, can refer to one or more preceding and/or succeeding examples. For example, in the appended claims, any of the claimed examples can be used in any combination.

As used herein, the terms “% by weight”, “wt %”, “weight percentage”, or “percentage by weight” are used interchangeably.

The front-end “blowing” reaction generated between the isocyanate and water is accelerated by certain polyurethane catalysts and is extremely important to producing a viable spray foam system. It has been surprisingly discovered that a narrow group of amine catalysts produce a stable and strong spray thermosetting foam when used in a hydrofluoroolefin (HFO) containing polyol resin blend. In at least one example, the polyol resin blend described herein can include one or more active hydroxyl compounds, a silicone surfactant, a halogenated olefinic blowing agent, and an amine catalyst. The polyol resin blend can be used to generate a spray thermosetting foam by combining the isocyanate with the polyol resin blend described above.

Many amine catalysts and amine catalyst formulations can be used in HFO-containing polyol resin blends, however few are industrially useful. Various issues can arise including, without limitation, imbalance between catalyst stability and catalysts speed. For example, catalysts that are generally more stable with HFO blowing agents are not typically fast enough to produce a foam that does not collapse or drip, or the amount of them required in a system is not economically viable. Similarly, catalysts which are fast enough to produce a viable spray thermosetting foam are generally not sufficiently stable to be used in the HFO-containing polyol resin blend. For example, a dimorpholinodiethylether (DMDEE, aka JEFFCAT® DMDEE, commercially available from Huntsman) catalyst can be very stable in the presence of HFO blowing agents (described in U.S. Patent Publication 2020/012650 and U.S. Patent Publication 2012/0313035). However, due to the structure of the compound, DMDEE is not a sufficiently fast catalyst to be used as the primary catalyst for a sprayed thermosetting foam system. Other standard spray foam catalysts include, without limitation, JEFFCAT® ZF-20, JEFFCAT® PMDETA, JEFFCAT® ZF-10, JEFFCAT® Z-130, JEFFCAT® Z-110, and JEFFCAT® ZR-70 are sufficiently fast catalysts to have been traditionally used in spray thermosetting foam, but are very unstable when placed in a polyol resin blend with HFO blowing agents and can cause the formulation to fail within a few weeks of storage time.

Imidazole compounds are known to be stable when used in a polyol resin blend with HFO blowing agents (described in U.S. Patent Publication 2016/0130416; U.S. Pat. No. 9,556,303; WO 2020146442), but are strongly biased towards the gel reaction and front end of the spray thermosetting foam reaction. In an alternative resin blend, catalysts can be pre-reacted with acids which are known to increase stability of HFO systems by “blocking” the amine during storage and allowing the heat of the spray thermosetting foam reaction by “unblock” the amine (described in U.S. Pat. Nos. 9,453,115; 10,023,681; 10,066,071; U.S. Patent Publication 2020/0255581; U.S. Patent Publication 2019/0062515). However, introducing acids into the polyol resin blends can increase the occurrence of negative side-effects including, without limitation, slowing down other catalysts, reducing the cream time, increasing the catalyst load requirements, and increasing the corrosivity of the blend, which can damage metal components of spray thermosetting foam equipment. Due to the increased side effects, acid-blocking additives are generally avoided in spray thermosetting foam formulations.

In other applications, fast cream time may not be as critical, but is still desired. In such cases, acid-blocked blowing amines can be used to increase the resin stability within HFO systems. The present disclosure provides a polyol resin blend (also referred to herein as a “B-side” comprising (a) a sterically hindered amine catalyst and (b) a compound having a formula (OH)ₐ—R—(COOH)_{b} where R is selected from hydrogen, an alkyl, alkenyl, cycloaliphatic, aromatic, and alkylaromatic group, a and b are integers between 0 and 3 with the proviso that a+b≥1, and when a=1 and b=0, R is selected from an aromatic and alkylaromatic group. The compound having the formula (OH)ₐ—R—(COOH)_{b} can have from 1 to 12 carbon atoms and may be a carboxylic acid, a dicarboxylic, a tricarboxylic, a phenolic acid, a substituted phenolic acid or a hydroxy substituted derivative thereof. Examples of R alkyl groups may include, but are not limited to, methyl, ethyl, n-propyl, iso-propyl, propyl, butyl, iso-butyl, phenyl, ethylenyl, n-amyl, n-decyl or 2 ethylhexyl groups. While the aforementioned alkyl groups may comprise two available substitution sites, it is contemplated that additional hydrogens on the hydrocarbon could be replaced with further carboxyl and/or hydroxyl groups. In at least one example, compounds having the formula (OH)ₐ—R—(COOH)_{b} may include, but are not limited to, a hydroxyl-carboxylic acid, adipic acid, glutaric acid, succinic acid, formic acid, acetic acid, malonic acid, maleic acid, glycolic acid, lactic acid, 2-hydroxybutyric acid, citric acid, polyacrylic acid, adipic-glutaric-succinic (AGS) acid, phenol, cresol, hydroquinone, or combinations thereof. AGS is a mixture of dicarboxylic acids (i.e., adipic acid, glutaric acid, and succinic acid) which can be obtained as a by-product of the oxidation of cyclohexanol and/or cyclohexanone in the adipic acid manufacturing process. Suitable AGS acids that may be used include RHODIACID® acid (available from Solvay S.A.), DIBASIC acid (available from Invista S.a.r.l), FLEXATRAC™-AGS-200 acid (available from Ascend Performance Materials LLC), and glutaric acid, technical grade (AGS) (available from Lanxess A.G.).

In an alternative example, sterically hindered catalysts have been used to increase stability of HFO systems. Analysis has shown that adding a bulkier alkyl group around the amines appears to slow down the reactive degradation of the HFO molecules and thereby increase the stability of the system. For example, in U.S. Pat. No. 9,550,854, discloses the use of hindered catalysts including, without limitation, dicyclohexylmethylamine, diisopropylethylamine, and dicyclohexylamine greatly reduced the degradation of the HFO blowing agent. However, the catalysts highlighted in this study were only determined to be suitable for pour-in-place foams, as they produced gel times of less than about 100 seconds. As such, these catalysts are not suitable for spray foam because of the slow reactivity. A hindered catalyst, dicyclohexylmethylamine, has been used in HFO systems (U.S. Patent Publication 2017/0066867 and U.S. Patent Publication 2019/0092920), but no evidence was provided that such catalyst can provide a cream time sufficient for use in a spray foam system. In fact, U.S. Patent Publication 2019/0136005 indicates that high levels of metal catalysts (including, without limitation, tin, bismuth, lead, zinc) must be used when slow, hindered amines are utilized as a catalyst in order to make up for the slow reactivity of the amines.

All amine catalysts facilitate this “blowing” reaction to some degree, but certain molecular structures are known to provide the fastest and most selective catalysis. Specifically, catalysts containing tertiary amines linked to ether groups by two carbons, as shown below, excel at catalyzing the blowing reaction.

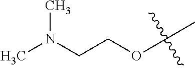 [SMILES: *OCCN(C)C]

Examples of commercially available catalysts in this category include, without limitation, JEFFCAT® ZF-20, JEFFCAT® ZF-10, JEFFCAT® LE-30, and JEFFCAT® ZR-70. In particular, catalysts comprising the bisaminoethylether (BAEE) moiety, such as JEFFCAT® ZF-20, can be very strong blowing catalysts, likely the result of the compound's ability to complex with water molecules and activate them towards reaction with isocyanates, as indicated in the structure below.

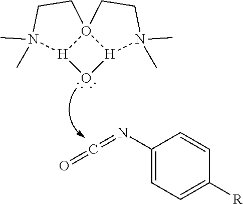

However, commercially available catalysts having the BAEE moiety are unstable when used in HFO systems due to the amine's strong nucleophilicity. Some BAEE moiety-containing amines have been analyzed. Specifically, U.S. Patent Publication 2019/0315905 describes the use of sterically hindered amines with the general structure R₁R₂N-[A-NR₃]ₙR₄ where R₁—R₄ can include alkyl groups (among others), A is an ether group (among others), and n is 0-3 with HFO blowing agents. However, only an extremely small subset of these disclosed structures were actually produced and tested, none of which provided fast reactivity in a sprayed foam system.

Some HFO-stable formulations were described, (U.S. Pat. No. 10,308,783) which were made using antioxidants and catalysts with the general structure R₁R₂N(CH₂)₂X, where R₁ and R₂ are the same or different and are each selected from a C₁-C₆ alkyl group and/or an alkanol group; X is O(CH₂)₂Y, OH, or NR₃ (CH₂)₂Y, where R₃ is a C₁-C₆ alkyl group or an alkanol group, and Y is OH or NR₄R₅, where R₄ and R₅ are the same or different and are each C₁-C₆ alkyl group or an alkanol group, subject to the proviso that the compound contains at least one ether and/or hydroxyl group. However, the described structure represents a very large set of compounds, very few of which were exemplified and/or tested. Of the compounds tested, significant shifts in reactivity were observed after only 7 days, which renders these systems industrially useless. This work did not synthesize or test any products with alkylamino groups greater than C₁.

Finally, catalyst compositions having the structure below have been described (WO 2020174030):

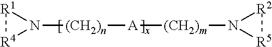

where A is O, X is 0 to 6, n and m are each independently 1 to 6, and R₁ and R₂ are each independently C₂-C₈ alkyl, and R₄ and R₅ are —CH₃ groups. The multitude of possible compounds described by this generic structure was discussed as being applicable in polyurethane formulations with HFO blowing agents, but no corresponding compositions were synthesized, exemplified, or tested in HFO formulations.

As indicated, while various Markush structures are disclosed in the prior art, no examples of such structures have been synthesized or tested that (a) contain the BAEE structure, (b) are fast enough catalysts for spray foam, and (c) are stable with HFO blowing agents. There are a vast number of possible compounds covered by these Markush structures, and it is not obvious to one skilled in the art which catalysts will provide industrially useful balance of catalytic speed and HFO stability. An amine catalyst having the below structure has been surprisingly found to provide an industrially viable spray foam.

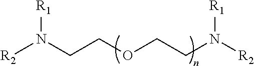

In at least one example, an amine of the above structure where R₁ is an ethyl, isopentane, isopropyl, or isobutyl group, R₂ is a methyl, ethyl, or isopropyl group, and n is selected from 1, 2, or 3 can produce a strong and stable foam. Such catalysts have been determined to produce an effective spray thermosetting foam when used in an amount of about 0.1% to about 10% by weight of the total weight of the polyol resin blend. In an additional example, the amount of catalyst used can be from about 0.3% to about 7% by weight, based on the total weight of the polyol resin blend. In yet another example, the amount of catalyst used can be from about 0.5% to about 5% by weight, based on the total weight of the polyol resin blend.

In some instances, the amine catalyst can be a combination of two or more catalysts disclosed herein. For example, the amine catalyst may include a combination of an imidazole catalyst and a sterically hindered amine catalyst, for example, a catalyst having the structure

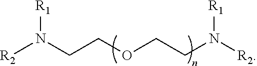

In at least one example, the amine catalyst can include a mixture of from about 10% to about 80% by weight of an imidazole catalyst and from about 20% to about 90% by weight of the catalyst having the above structure, where the % by weight is based on the total weight of the mixture and the amount of the imidazole catalyst plus the amount of the catalyst having the above structure equals 100%. In an alternative example, the amine catalyst can include a mixture of from about 10% to about 70% by weight of an imidazole catalyst and from about 30% to about 90% by weight of the catalyst having the above structure or the amine catalyst can include a mixture of from about 10% to about 60% by weight of an imidazole and from about 40% to about 90% by weight of the catalyst having the above structure, where the % by weight is based on the total weight of the mixture and the amount of the imidazole catalyst plus the amount of the catalyst having the above structure equals 100%.

A number of etheramine and BAEE-based compounds have been synthesized and tested and it has been surprisingly shown that only a narrow, non-obvious subset of these compounds have an industrially useful balance of catalyst speed, cream time, and HFO stability. Examples of the present synthesis reaction are provided below. However, the present disclosure is to be understood to not be limited in its application to the specific experiments, results, and laboratory procedures disclosed herein below. Rather, the Examples are simply provided as one of various embodiments and are meant to be exemplary and not exhaustive.

### EXAMPLES

### Example 1—Synthesis of N,N-isopropylmethylethanolamine

In a reaction vessel, 100 grams of N-isopropylethanolamine was mixed with a slight molar excess of formic acid and formaldehyde and heated to a temperature of 80° C. During the reaction, CO₂ gas was produced as is typical for the Eschweiler/Clarke methylation reaction. The resulting mixture was neutralized with aqueous sodium hydroxide and the amine was distilled under reduced pressure (boiling point 69° C. at 22 mmHg) to yield N,N-isopropylmethylethanolamine, structure provided as compound (I), below, at greater than 99% purity.

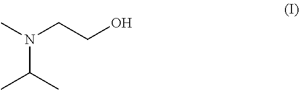

### Example 2—Synthesis of 2-(2-(isopropyl(methyl)amino)ethoxy)ethan-1-ol

In a reaction vessel, diglycolamine (DGA) was dissolved in a minimal amount of methanol and co-fed into a continuous high-pressure hydrogenation reactor with an equimolar amount of acetone and hydrogen gas at 150-190° C. and a pressure of 2000 psig, using a palladium on carbon (Pd/C) catalyst for the reduction. The resulting product was then fed through the same reactor, this time with a molar excess of formaldehyde and hydrogen gas at 100-140° C. and 2000 psig, over a supported polymetallic catalyst. This crude material was distilled under reduced pressure to yield a product of compound (II), below, in greater than 99% purity.

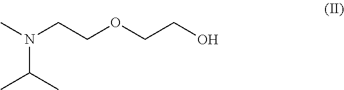

### Example 3-Synthesis of 2-((2-(isopropyl(methyl)amino)ethoxy)ethyl(methyl)amino) ethan-1-ol and 2-(isopropyl(2-(2-(isopropyl(methyl)amino)ethoxy)ethyl)amino)ethan-1-ol

In a reaction vessel, 2-((2-(2-aminoethoxy)ethyl)amino)ethan-1-ol was dissolved in a minimal amount of methanol and co-fed into a high-pressure hydrogenation reactor with 1 mole of acetone per mole of amine group and hydrogen gas at 150-190° C. and a pressure of 2000 psig, using a Pd/C catalyst for the reduction. The resulting product was then fed through the same reactor, this time with a molar excess of formaldehyde and hydrogen gas at 100-140° C. and 2000 psig, over a supported polymetallic catalyst. The resulting crude product was distilled, yielding two main fractions, compounds (III) and (IV), below.

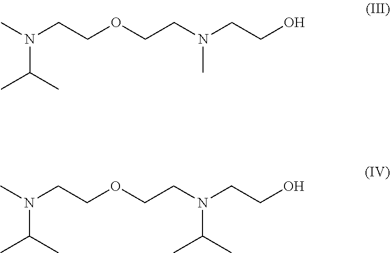 [SMILES: CC(C)N(C)CCOCCN(C)CCO ; CC(C)N(C)CCOCCN(CCO)C(C)C]

### Example 4—Synthesis of N,N′-diisopropyl-N,N′-dimethyl-bis (aminoethyl) ether and N,N,N′-triisopropyl-N-methyl-bis(aminoethyl)ether

In a reaction vessel, bis (aminoethyl) ether (BAEE) was dissolved into a minimal amount of methanol and co-fed into a high-pressure hydrogenation reactor along with 1.3 moles of acetone per amine group and hydrogen gas at 150-190° C. and a pressure of 2000 psig, using a Pd/C catalyst for the reduction. The resulting product was fed back into the same reactor, this time with an excess of formaldehyde and hydrogen gas at 100-140° C. and 2000 psig, over a supported polymetallic catalyst. The resulting crude mixture was distilled to yield two products, compounds (V) and (VI), below, in greater than 99% purity.

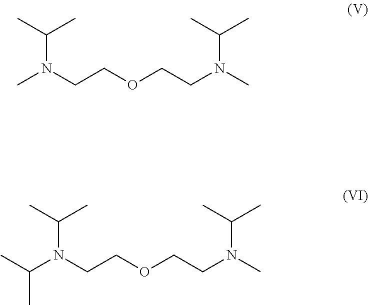

### Example 5—Synthesis of 2-((2-(isopropyl(methyl)amino)ethyl)(methyl)amino)ethan-1-ol

In a reaction vessel, aminoethylethanolamine (AEEA) was dissolved into a minimal amount of methanol and co-fed into a high-pressure hydrogenation reactor of methanol and co-fed into a high-pressure hydrogenation reactor along with 0.6 moles acetone per amine group and hydrogen gas at 150-190° C. and a pressure of 2000 psig, using a Pd/C catalyst for the reduction. The resulting product was fed back into the same reactor, this time with a molar excess of formaldehyde and hydrogen gas at 100-140° C. and 2000 psig, over a supported polymetallic catalyst. The crude mixture was then distilled to yield a product of compound (VII), below, at greater than 99% purity.

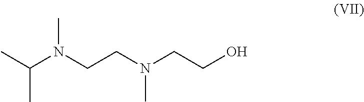

### Example 6—Synthesis of N-methyl-2-morpholino-N-(2-morpholinoethyl)ethan-1-ol

In a reaction vessel, hydroxyethylmorpholine was fed into a high-pressure reactor and reductively aminated with a mixture of ammonia (15-30-fold molar excess) and hydrogen (10X molar excess) over a supported polymetallic catalyst at 150-200° C. and a pressure of 2000 psig. The resulting product was vacuum-stirpped to remove light materials and the remaining heavy materials were fed back into the same reactor, this time with a molar excess of formaldehyde and hydrogen gas at 100-140° C. and 2000 psig, over a supported polymetallic catalyst. The crude mixture was then distilled to yield a product of compound (VIII), below, at greater than 99% purity.

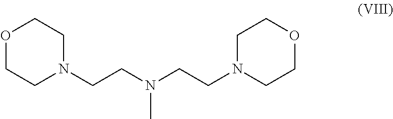 [SMILES: CN(CCN1CCOCC1)CCN1CCOCC1]

### Example 7-Synthesis of N,N′-((ethane-1,2-diylbis(oxy))bis(ethane-2,1-diyl))bis(N-methylpropan-2-amine)

In a reaction vessel, 2,2′-(ethane-1,2-diylbis(oxy))bis(ethan-1-amine) was dissolved into a minimal amount of methanol and co-fed into a high-pressure hydrogenation reactor along with 1.3 moles of acetone per amine group and hydrogen gas at 150-190° C. and a pressure of 2000 psig, using a Pd/C catalyst for the reduction. The resulting product was fed back into the same reactor, with an excess of formaldehyde and hydrogen gas at 100-140° C. and 2000 psig, over a supported polymetallic catalyst. The resulting crude mixture was distilled to yield compound XVI, shown below, at about 99% purity.

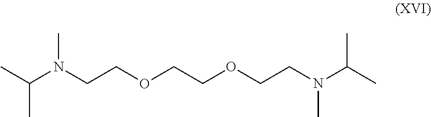 [SMILES: CC(C)N(C)CCOCCOCCN(C)C(C)C]

### Example 8—Synthesis of N,N′-(oxybis(ethane-2,1-diyl))bis(N-methylbutan-2-amine)

In a reaction vessel, BAEE was dissolved into a minimal amount of methanol and co-fed into a high-pressure hydrogenation reactor along with 1.3 moles of methylethylketone (MEK) per amine group and hydrogen gas at 150-190° C. and a pressure of 2000 psig, using a Pd/C catalyst for the reduction. The resulting product was fed back into the same reactor, this time with an excess of formaldehyde and hydrogen gas at 100-140° C. and 2000 psig, over a supported polymetallic catalyst. The resulting crude mixture was distilled to yield compound XVII, shown below, in greater than 99% purity.

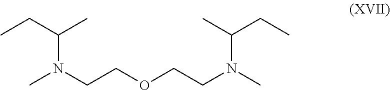 [SMILES: CCC(C)N(C)CCOCCN(C)C(C)CC]

### Example 9—Synthesis of tetraethyl-bis-dimethylaminoethylether

In a reaction vessel, BAEE was dissolved into a minimal amount of methanol and co-fed into a high-pressure hydrogenation reactor along with an excess of acetaldehyde and hydrogen gas at 150-190° C. and a pressure of 2000 psig, using a Pd/C catalyst for the reduction. The resulting crude mixture was distilled to yield compound XVIII, shown below, in greater than 99% purity.

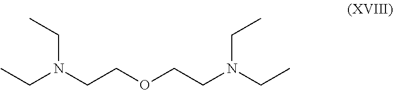

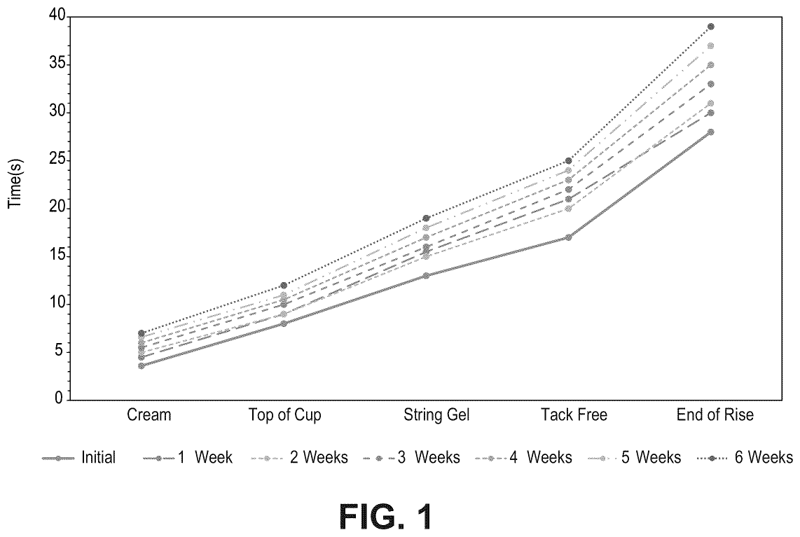

The stability of the compound XVIII was tracked over a period of several weeks, as shown in Table 1 and illustrated in FIG. 1:

TABLE 1

| Properties | Initial | 1 Week | 2 Weeks | 3 Weeks | 4 Weeks | 5 Weeks | 6 Weeks |
|---|---|---|---|---|---|---|---|
| Cream (s) | 3.6 | 4.5 | 5 | 5.5 | 6 | 6.6 | 7 |
| Top of Cup (s) | 8 | 9 | 9 | 10 | 10.5 | 11 | 12 |
| String Gel (s) | 13 | 15.5 | 15 | 16 | 17 | 18 | 19 |
| Tack Free (s) | 17 | 21 | 20 | 22 | 23 | 24 | 25 |
| End of Rise (s) | 28 | 30 | 31 | 33 | 35 | 37 | 39 |

As indicated, the stability of the compound did not decrease significantly over the six-week period.

### Example 10

In a reaction vessel, BAEE was dissolved into a minimal amount of methanol and co-fed into a high-pressure hydrogenation reactor along with 1.2 to 3 moles of isobutyraldehyde per mol amine group and hydrogen gas at 140-190° C. and a pressure of 2000 psig, using a Pd/C catalyst for the reduction. The resulting product was fed back into the same reactor, this time with an excess of formaldehyde and hydrogen gas at 100-140° C. and 2000 psig, over a supported polymetallic catalyst. The resulting crude mixture was distilled to yield the following compound, shown below.

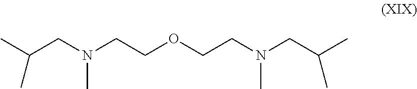 [SMILES: CC(C)CN(C)CCOCCN(C)CC(C)C]

### COMPARATIVE EXAMPLES

Other compounds were produced for comparison in HFO stability and foam reactivity studies including the following compounds:

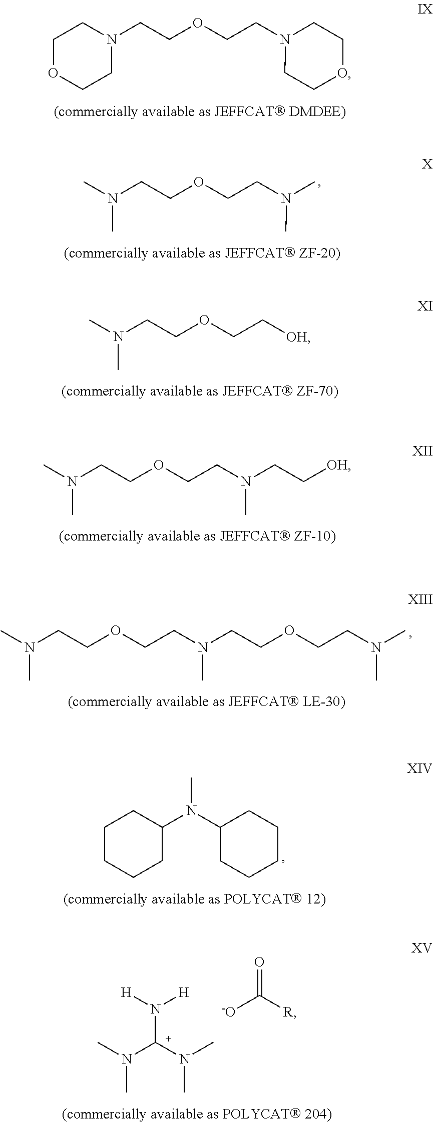

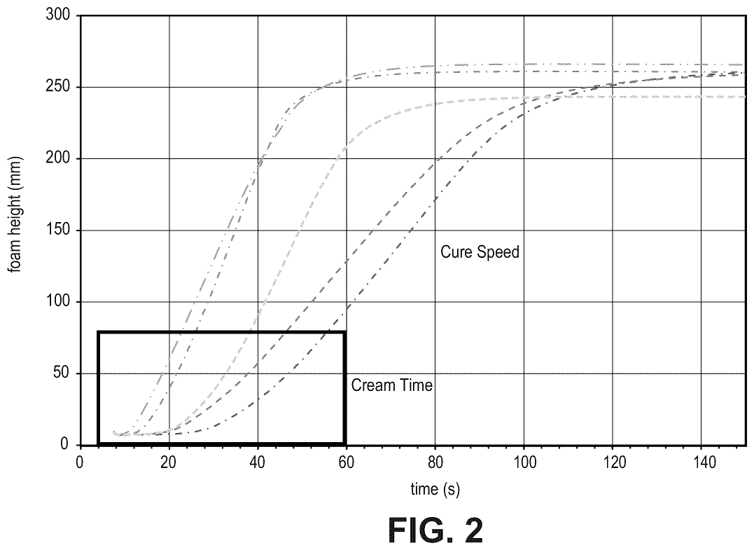

Three factors were evaluated for the spray foam systems described herein using the catalysts described herein: stability, cream time, and catalyst speed. Stability was determined by storing a system containing the catalyst, at a 5% catalyst concentration, for a period of 6 weeks at a temperature at 50° C. The reactivity of the system was measured before and after the 6 week period and recorded as a percent of the original gel time, and the information recorded is used to quantify the stability for each system. A higher percentage (larger drift) is less effective than a lower percentage. Useful systems need to have about 50% drift or less to be industrially viable. Cream time and catalyst speed were measured using an ultrasonic rate-of-rise measurement system. A polyol blend containing 1% of each catalyst was rapidly mixed with the isocyanate in a cup and placed under the instrument. Cream time was taken as the inflection point where the foam mixture beings to rise. Catalyst “curing speed” was determined as the slope of the line during the linear portion of the foam growth curve. A slope of greater than or equal to 5 mm/sec is required for the catalyst to be industrially viable. This analysis is exemplified in FIG. 2.

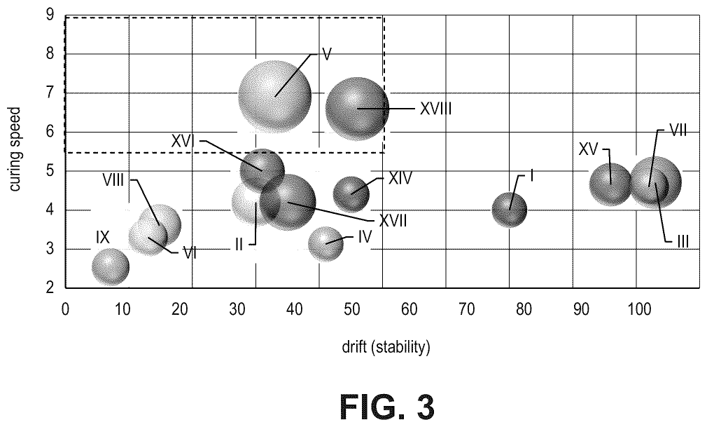

The cream time, catalyst speed, and catalyst stability data can be plotted on a “bubble” graph to combine each of the data values and show the most promising catalytic compounds. An exemplary bubble graph of the example catalyst described above is provided in FIG. 3. As indicated in the graph, the x-axis represents the stability, as drift in gel time, of the catalyst. The higher the drift, the worse the stability of the catalyst in an HFO system. The y-axis represents the curing speed, which represents how fast the foam rises during its post-cream rise period. The bubble size represents the inverse of cream time of the catalyst, so a larger the bubble size indicates a faster cream time. To be industrially viable in HFO systems, a faster cream time indicates a more suitable catalyst. Catalysts that are deficient in any one category will not be stable or strong enough to be used as blowing catalysts for HFO systems. Comparative examples X-XIII are not shown on the graph as the stability drift was over 300%.

The most industrially viable catalysts are present in the top left quadrant of the graph of FIG. 3, surrounded by dashed line A. Only two catalysts are fully present in the industrially viable quadrant, compounds V and XVIII. As indicated in the graph, compound V has the fastest cream time of this class of catalysts. The graph unexpectedly shows that compounds V and XVIII have an exceptional combination of speed, cream time, and stability. Reviewing only isopropyl-modified compounds, compound V shows significantly better performance than the others, which is surprising given how similar the structures are to each other. Multiple other examples having an isopropyl/methyl combination on the same nitrogen, including compounds I, II, III, IV, VII, and XVI, however none of these compounds illustrated the exceptional properties of compound V. The unexpected properties illustrated by compound V when used in HFO systems would not have been obvious based on the prior art described herein. As clearly illustrated, similarly structured catalysts do not provide the same benefits.

From the above description, the present disclosure is well adapted to carry out the object and to attain the advantages mentioned herein as well as those inherent in the present disclosure. While exemplary embodiments of the present disclosure have been described for the purposes of the disclosure, it will be understood that numerous changes may be made which will readily suggest themselves to those skilled in the art which can be accomplished without departing from the scope of the present disclosure and the appended claims.

What is claimed is:

1. A polyol resin blend suitable for rigid foam applications comprising one or more active hydroxyl compounds, a silicone surfactant, a halogenated olefinic blowing agent, and an amine catalyst with the structure: 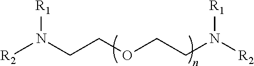
wherein R₁ is an ethyl, isopentane, isopropyl, or isobutyl group, R₂ is a methyl, ethyl, or isopropyl group, and n=1, 2, or 3.

2. The polyol resin blend according to claim 1, further comprising a compound having a formula (OH)ₐ—R—(COOH)_{b}, wherein R is one of a hydrogen, an alkyl, alkenyl, cycloaliphatic, aromatic, or alkylaromatic group, a and b are integers between 0 and 3, wherein a+b≥1, and when a=1 and b=0, R is selected from an aromatic group and an alkylaromatic group.

3. The polyol resin blend according to claim 2, wherein R is a methyl, ethyl, n-propyl, iso-propyl, propyl, butyl, iso-butyl, phenyl, ethylenyl, n-amyl, n-decyl or 2 ethylhexyl group.

4. The polyol resin blend according to claim 1, wherein n=1 or 2.

5. The polyol resin blend according to claim 1, wherein R₁ is an isopropyl or isobutyl group.

6. The polyol resin blend according to claim 1, wherein R₂ is a methyl group.

7. The polyol resin blend according to claim 1, wherein R₁ and R₂ are ethyl.

8. A polyurethane foam composition comprising an isocyanate and an HFO-containing polyol resin blend comprising a catalyst with the structure 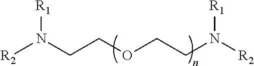
wherein R₁ is an ethyl, isopentane, isopropyl, or isobutyl group, R₂ is a methyl, ethyl, or isopropyl group, and n=1, 2, or 3.

9. The polyurethane foam composition according to claim 8, further comprising a compound having a formula (OH)ₐ—R—(COOH)_{b}, where R is one of a hydrogen, an alkyl, alkenyl, cycloaliphatic, aromatic, or alkylaromatic group, a and b are integers between 0 and 3, wherein a+b≥1, and when a=1 and b=0, R is selected from an aromatic group and an alkylaromatic group.

10. The polyurethane foam composition according to claim 9, wherein R is a methyl, ethyl, n-propyl, iso-propyl, propyl, butyl, iso-butyl, phenyl, ethylenyl, n-amyl, n-decyl or 2 ethylhexyl group.

11. The polyurethane foam composition according to claim 8, wherein n=1 or 2.

12. The polyurethane foam composition according to claim 8, wherein R₁ is an isopropyl or isobutyl group.

13. The polyurethane foam composition according to claim 8, wherein R₂ is methyl.

14. A method of improving the stability and reactivity of an HFO-containing polyol resin blend comprising incorporating 0.3-7% by weight, based on the total weight of the HFO-containing polyol resin blend, of a catalyst with the structure 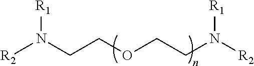
wherein R₁ is an ethyl, isopentane, isopropyl, or isobutyl group, R₂ is a methyl, ethyl, or isopropyl group, and n=1, 2, or 3 into the HFO-containing polyol resin blend.

15. The method according to claim 14, wherein R₁ and R₂ are ethyl.

16. The method according to claim 15, wherein n=1.

17. A polyurethane amine catalyst composition comprising a mixture of (a) 10-60% by weight of an imidazole catalyst and (b) 10-60% by weight of a catalyst with the structure 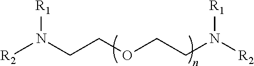
wherein R₁ is an ethyl, isopentane, isopropyl, or isobutyl group, R₂ is a methyl, ethyl, or isopropyl group, and n=1, 2, or 3, where the % by weight is based on the total weight of the mixture and the amount of the imidazole catalyst plus the amount of the catalyst having the above structure equals 100%.

18. The polyurethane amine catalyst composition to claim 17, wherein n=1 or 2.

19. A polyurethane foam comprising a foam obtained from the reaction of an isocyanate with the polyol resin blend of claim 1.

20. A polyurethane foam comprising a foam obtained from the reaction of an isocyanate with the polyurethane amine catalyst composition of claim 17.
